(19) United States
(12) Patent Application Publication
(10) Pub. No.: US 2021/0308987 A1
(43) Pub. Date: Oct. 7, 2021

(54) LAMINATE, AND METHOD FOR PRODUCING LAMINATE

(71) Applicant: TOYOBO CO., LTD., Osaka (JP)

(72) Inventors: Tetsuo OKUYAMA, Otsu (JP); Miyuki HAYASHI, Otsu (JP); Shunsuke ICHIMURA, Otsu (JP); Kaya TOKUDA, Otsu (JP); Masahiro YAMASHITA, Otsu (JP)

(73) Assignee: TOYOBO CO., LTD., Osaka (JP)

(21) Appl. No.: 17/268,947

(22) PCT Filed: Aug. 7, 2019
(86) PCT No.: PCT/JP2019/031094

§ 371 Date: Feb. 16, 2021

(30) Foreign Application Priority Data
Aug. 20, 2018 (JP) 2018-154038

(51) Int. Cl. B32B 7/12; B32B 7/06; B32B 7/027; B32B 17/10

(52) U.S. Cl. CPC B32B 7/12; B32B 7/06; B32B 2307/306; B32B 17/10; B32B 7/027

(57) ABSTRACT

A laminate comprising a heat-resistant polymer film, an inorganic substrate, and a polyamine compound layer formed using a polyamine compound, wherein the polyamine compound layer is formed between the heat-resistant polymer film and the inorganic substrate.

### TECHNICAL FIELD

The present invention relates to a laminate and a method for producing a laminate.

### BACKGROUND ART

In recent years, for the purpose of decreasing the weight, size, and thickness of and imparting flexibility to functional elements such as semiconductor elements, MEMS elements, and display elements, technological development for forming these elements on polymer films has been actively carried out. In other words, as materials for substrates of electronic parts such as information and communication equipment (broadcasting equipment, mobile radio, portable communication equipment, and the like), radar, and high-speed information processing equipment, ceramics which exhibit heat resistance and can cope with increases in frequencies (reaching the GHz band) of the signal band of information and communication equipment have been conventionally used. However, ceramics are not flexible and are also hardly thinned and thus have a drawback that the applicable fields are limited, and polymer films have recently been used as substrates.

When functional elements such as semiconductor elements, MEMS elements, and display elements are formed on the surface of polymer films, it is ideal to perform processing by a so-called roll-to-roll process which utilizes the flexibility that is a feature of polymer films. However, in industries such as semiconductor industry, MEMS industry, and display industry, process technologies for rigid flat substrates such as wafer bases or glass substrate bases have been so far constructed. Hence, in order to form functional elements on polymer films utilizing the existing infrastructure, a process is used in which the polymer films are bonded to, for example, rigid supports made of inorganic substances such as glass plates, ceramic plates, silicon wafers, and metal plates, desired elements are formed on the laminates, and then the polymer films and desired elements are peeled off from the supports.

However, in the process of forming a desired functional element on a laminate in which a polymer film and a support made of an inorganic substance are bonded to each other, the laminate is often exposed to a high temperature. For example, in the formation of functional elements such as polysilicon and oxide semiconductors, a step performed in a temperature region of about 200° C. to 600° C. is required. In addition, a temperature of about 200° C. to 300° C. may be applied to the film when a hydrogenated amorphous silicon thin film is fabricated, and heating at about 450° C. to 600° C. may be required in order to heat and dehydrogenate amorphous silicon and obtain low-temperature polysilicon. Hence, the polymer film composing the laminate is required to exhibit heat resistance, but as a practical matter, polymer films which can withstand practical use in such a high temperature region are limited. In addition, it is generally conceivable to use a pressure sensitive adhesive or an adhesive to bond a polymer film to a support, but heat resistance is also required for the joint surface (namely, the adhesive or pressure sensitive adhesive for bonding) between the polymer film and the support at that time. However, since ordinary adhesives and pressure sensitive adhesives for bonding do not exhibit sufficient heat resistance, bonding with an adhesive or a pressure sensitive adhesive cannot be adopted when the formation temperature of functional element is high.

Since it is considered that there are no pressure sensitive adhesives or adhesives exhibiting sufficient heat resistance, a technology in which a polymer solution or a polymer precursor solution is applied onto an inorganic substrate, dried and cured on the inorganic substrate to form a film, and used for these applications has been conventionally adopted in the above-mentioned applications. However, the polymer film obtained by such means is brittle and easily torn and thus the functional element formed on the surface of this polymer film is often destroyed when being peeled off from the inorganic substrate. In particular, it is extremely difficult to peel off a large-area film from an inorganic substrate, and it is not possible to attain an industrially viable yield.

In view of these circumstances, a laminate in which a polyimide film which exhibits excellent heat resistance, is tough, and can be thinned is bonded to an inorganic substrate with a silane coupling agent interposed therebetween has been proposed as a laminate of a polymer film and an inorganic substrate for forming a functional element (for example, see Patent Documents 1 to 3).

### PRIOR ART DOCUMENTS

### Patent Documents

Patent Document 1: JP-B-5152104

Patent Document 2: JP-B-5304490

Patent Document 3: JP-B-5531731

### SUMMARY OF THE INVENTION

### Problems to be Solved by the Invention

The present inventors have further conducted diligent research on a laminate in which a heat-resistant polymer film and an inorganic substrate are bonded to each other. As a result, the present inventors have surprisingly found out that the laminate exhibits sufficient heat resistance equal to or higher than that when a silane coupling agent is used and the adhesive strength between the heat-resistant polymer film and the inorganic substrate is favorable when a polyvalent amine compound layer is formed between the heat-resistant polymer film and the inorganic substrate, and have completed the present invention.

### Means for Solving the Problems

In other words, the laminate according to the present invention includes:
a heat-resistant polymer film;
an inorganic substrate; and
a polyvalent amine compound layer formed using a polyvalent amine compound, and in the laminate,
the polyvalent amine compound layer is formed between the heat-resistant polymer film and the inorganic substrate.

According to the configuration, since a polyvalent amine compound layer is formed between a heat-resistant polymer film and an inorganic substrate, the laminate exhibits sufficient heat resistance and the adhesive strength between the heat-resistant polymer film and the inorganic substrate is favorable as is clear from Examples as well.

In the configuration, it is preferable that a 90° initial peel strength between the heat-resistant polymer film and the inorganic substrate is 0.05 N/cm or more.

If the 90° initial peel strength is 0.05 N/cm or more, it is possible to prevent the polymer film from peeling off from the inorganic substrate before and during device formation.

In the configuration, it is preferable that a 90° peel strength between the heat-resistant polymer film and the inorganic substrate is 0.5 N/cm or less after the laminate is heated at 500° C. for 0.1 hour.

If the peel strength is 0.5 N/cm or less, the inorganic substrate and the polymer film are easily peeled off from each other after device formation.

The method for producing a laminate according to the present invention includes:

a step A of forming a polyvalent amine compound layer on an inorganic substrate; and

a step B of bonding a heat-resistant polymer film to the polyvalent amine compound layer.

According to the configuration, a laminate can be obtained by forming a polyvalent amine compound layer on an inorganic substrate and bonding a heat-resistant polymer film to the polyvalent amine compound layer. Hence, the productivity is greatly excellent. In addition, the laminate thus obtained exhibits sufficient heat resistance and the adhesive strength between the heat-resistant polymer film and the inorganic substrate is favorable. This is clear from the description of Examples as well.

In the configuration, it is preferable that a 90° initial peel strength between the heat-resistant polymer film and the inorganic substrate after the step B is 0.05 N/cm or more.

If the 90° initial peel strength is 0.05 N/cm or more, it is possible to prevent the heat-resistant polymer film from peeling off from the inorganic substrate before and during device formation.

In the configuration, it is preferable that a 90° peel strength between the heat-resistant polymer film and the inorganic substrate is 0.5 N/cm or less after the step B and the laminate is further heated at 500° C. for 1 hour.

If the 90° peel strength is 0.5 N/cm or less, the inorganic substrate and the polymer film are easily peeled off from each other after device formation.

### Effect of the Invention

According to the present invention, it is possible to provide a laminate having sufficient heat resistance and favorable adhesive strength between the heat-resistant polymer film and the inorganic substrate. In addition, it is possible to provide a method for producing the laminate.

### BRIEF DESCRIPTION OF THE DRAWINGS

FIG. 1 is a schematic view of an experimental apparatus for applying a polyvalent amine compound to a glass substrate.

FIG. 2 is a schematic view of an experimental apparatus for applying a polyvalent amine compound to a glass substrate.

### MODE FOR CARRYING OUT THE INVENTION

Hereinafter, embodiments of the present invention will be described.

### <Laminate>

The laminate according to the present embodiment includes:

a heat-resistant polymer film;

an inorganic substrate; and

a polyvalent amine compound layer formed using a polyvalent amine compound, and in the laminate,

the polyvalent amine compound layer is formed between the heat-resistant polymer film and the inorganic substrate.

In the laminate, the 90° initial peel strength between the heat-resistant polymer film and the inorganic substrate is preferably 0.05 N/cm or more and more preferably 0.1 N/cm or more. The 90° initial peel strength is preferably 0.25 N/cm or less and more preferably 0.2 N/cm or less. If the 90° initial peel strength is 0.05 N/cm or more, it is possible to prevent the heat-resistant polymer film from peeling off from the inorganic substrate before and during device formation. If the 90° initial peel strength is 0.25 N/cm or less, the inorganic substrate and the heat-resistant polymer film are easily peeled off from each other after device formation. In other words, if the 90° initial peel strength is 0.25 N/cm or less, the inorganic substrate and the heat-resistant polymer film are easily peeled off from each other even if the peel strength between the inorganic substrate and the heat-resistant polymer film slightly increases during device formation.

In the present specification, the 90° initial peel strength refers to the 90° peel strength between the inorganic substrate and the heat-resistant polymer film after the laminate is heat-treated at 200° C. for 1 hour in an atmospheric ambience.

The measurement conditions for the 90° initial peel strength are as follows.

The heat-resistant polymer film is peeled off from the inorganic substrate at an angle of 90°.

The measurement is performed 5 times and the average value thereof is taken as the measured value.

Measured temperature: Room temperature (25° C.)

Peeling speed: 100 mm/min

Ambience: Atmosphere

Width of measured sample: 2.5 cm

More specifically, the method described in Examples is adopted.

The 90° peel strength between the heat-resistant polymer film and the inorganic substrate is preferably 0.50 N/cm or less, more preferably 0.3 N/cm or less, and further preferably 0.2 N/cm or less after the laminate is heat-treated at 200° C. for 1 hour in an atmospheric ambience and then further heated at 500° C. for 1 hour. The 90° peel strength is preferably 0.05 N/cm or more and more preferably 0.1 N/cm or more. If the 90° peel strength is 0.05 N/cm or less, the inorganic substrate and the heat-resistant polymer film are easily peeled off from each other after device formation. If the 90° peel strength is 0.5 N/cm or more, it is possible to prevent the heat-resistant polymer film from peeling off from the inorganic substrate at an unintended stage such as during device formation.

The measurement conditions for the 90° peel strength are similar to the measurement conditions for the initial peel strength.

### <Heat-Resistant Polymer Film>

In the present specification, the heat-resistant polymer is a polymer having a melting point of 400° C. or more and preferably 500° C. or more and a glass transition temperature of 250° C. or more, preferably 320° C. or more, and more preferably 330° C. or more. Hereinafter, the heat-resistant polymer is also simply referred to as a polymer in order to avoid complication. In the present specification, the melting point and the glass transition temperature are determined by differential thermal analysis (DSC). Incidentally, in a case where the melting point exceeds 500° C., it may be determined whether or not the melting point has reached by visually observing the thermal deformation behavior when the heat-resistant polymer is heated at this temperature.

Examples of the heat-resistant polymer film (hereinafter, also simply referred to as a polymer film) includes films of polyimide-based resins (for example, aromatic polyimide resin and alicyclic polyimide resin) such as polyimide, polyamide-imide, polyetherimide, and fluorinated polyimide; copolymerized polyesters (for example, fully aromatic polyesters and semi-aromatic polyesters) such as polyethylene, polypropylene, polyethylene terephthalate, polybutylene terephthalate, and polyethylene-2,6-naphthalate; copolymerized (meth)acrylates represented by polymethylmethacrylate; polycarbonates; polyamides; polysulfones; polyethersulfones; polyetherketones; cellulose acetates; cellulose nitrates; aromatic polyamides; polyvinyl chloride; polyphenols; polyarylates; polyphenylene sulfides; polyphenylene oxides; and polystyrenes.

However, since the polymer film is premised on being used in a process involving heat treatment at 450° C. or more, those that can actually foe adopted among the exemplified polymer films are limited. Among the polymer films, a film obtained using a so-called super engineering plastic is preferable, and more specific examples include an aromatic polyimide film, an aromatic amide film, an aromatic amide-imide film, an aromatic benzoxazole film, an aromatic benzothiazole film, and an aromatic benzimidazole film.

The details of the polyimide-based resin film (referred to as a polyimide film in some cases) which is an example of the polymer film will be described below. Generally, the polyimide-based resin film is obtained by: applying a polyamic acid polyimide precursor) solution which is obtained by a reaction between a diamine and a tetracarboxylic acid in a solvent, to a polyimide film-manufacturing support and drying the solution so as to form a green film (hereinafter, also called as a “polyamic acid film”); and treating the green film by heat at a high temperature so as to cause a dehydration ring-closure reaction on the polyimide film-manufacturing support or in a state of being peeled off from the support.

For the application of the polyamic acid (polyimide precursor) solution, it is possible to appropriately use, for example, conventionally known solution application means such as spin coating, doctor blade, applicator, comma coater, screen printing method, slit coating, reverse coating, dip coating, curtain coating, and slit die coating.

The diamines for composing the polyamic acid are not limited particularly, and aromatic diamines, aliphatic diamines, alicyclic diamines and the like which are usually used for polyimide synthesis can be used. In the light of the heat resistance, aromatic diamines are preferable, and among the aromatic diamines, aromatic diamines having benzoxazole structures are more preferable. If using the aromatic diamines having benzoxazole structures, a high elastic modulus, low heat shrinkability and a low coefficient of linear thermal expansion as well as the high heat resistance can be exhibited. The diamines can be used alone or in combination of two kinds or more.

The aromatic diamines having benzoxazole structures are not limited particularly, and examples thereof include: 5-amino-2-(p-aminophenyl)benzoxazole; 6-amino-2-(p-aminophenyl)benzoxazole; 5-amino-2-(m-aminophenyl)benzoxazole; 6-amino-2-(m-aminophenyl)benzoxazole; 2,2′-p-phenylenebis(5-aminobenzoxazole); 2,2′-p-phenylenebis(6-aminobenzoxazole); 1-(5-aminobenzoxazolo)-4-(6-aminobenzoxazolo)benzene; 2,6-(4,4′-diaminodiphenyl)benzo[1,2-d:5,4-d′]bisoxazole; 2,6-(4,4′-diaminodiphenyl)benzo[1,2-d:4,5-d′]bisoxazole; 2,6-(3,4′-diaminodiphenyl)benzo[1,2-d:5,4-d′]bisoxazole; 2,6-(3,4′-diaminodiphenyl)benzo[1,2-d:4,5-d′]bisoxazole; 2,6-(3,3′-diaminodiphenyl)benzo[1,2-d:5,4-d′]bisoxazole; 2,6-(3,3′-diaminodiphenyl)benzo[1,2-d:4,5-d′]bisoxazole; and the like.

Examples of the aromatic diamines except the above-described aromatic diamines having benzoxazole structures include: 2,2′-dimethyl-4,4′-diaminobiphenyl; 1,4-bis[2-(4-aminophenyl)-2-propyl]benzene(bisaniline); 1,4-bis(4-amino-2-trifluoromethylphenoxy)benzene; 2,2′-ditrifluoromethyl-4,4′-diaminobiphenyl; 4,4′-bis(4-aminophenoxy)biphenyl; 4,4′-bis(3-aminophenoxy)biphenyl; bis[4-(3-aminophenoxy)phenyl]ketone; bis[4-(3-aminophenoxy)phenyl]sulfide; bis[4-(3-aminophenoxy phenyl]sulfone; 2,2-bis[4-(3-aminophenoxy)phenyl]propane; 2,2-bis[4-(3-aminophenoxy)phenyl]-1,1,1,3,3,3-hexafluoropropane; m-phenylenediamine; o-phenylenediamine; p-phenylenediamine; m-aminobenzylamine; p-aminobenzylamine; 3,3′-diaminodiphenylether; 3,4′-diaminodiphenylether; 4,4′-diaminodiphenylether; 3,3′-diaminodiphenylsulfide; 3,3′-diaminodiphenylsulfoxide; 3,4′-diaminodiphenyisulfoxide; 4,4′-diaminodiphenylsulfoxide; 3,3′-diaminodiphenylsulfone; 3,4′-diaminodiphenylsulfone; 4,4′-diaminodiphenylsulfone; 3,3′-diaminobenzophenone; 3,4′-diaminobenzophenone; 4,4′-diaminobenzophenone; 3,3′-diaminodiphenylmethane; 3,4′-diaminodiphenylmethane; 4,4′-diaminodiphenylmethane; bis[4-(4-aminophenoxy)phenyl]methane; 1,1-bis[4-(4-aminophenoxy)phenyl]ethane; 1,2-bis[4-(4-aminophenoxy)phenyl]ethane; 1,1-bis[4-(4-aminophenoxy)phenyl]propane; 1,2-bis[4-(4-aminophenoxy)phenyl]propane; 1,3-bis[4-(4-aminophenoxy)phenyl]propane; 2,2-bis[4-(4-aminophenoxy)phenyl]propane; 1,1-bis[4-(4-aminophenoxy)phenyl]butane; 1,3-bis[4-(4-aminophenoxy)phenyl]butane; 1,4-bis[4-(4-aminophenoxy)phenyl]butane; 2,2-bis[4-(4-aminophenoxy)phenyl]butane; 2,3-bis[4-(4-aminophenoxy)phenyl]butane; 2-[4-(4-aminophenoxy)phenyl]-2-[4-(4-aminophenoxy)-3-methylphenyl]propane; 2,2-bis[4-(4-aminophenoxy)-3-methylphenyl]propane; 2-[4-(4-aminophenoxy)phenyl]-2-[4-(4-aminophenoxy)-3,5-dimethylphenyl]propane; 2,2-bis[4-(4-aminophenoxy)-3,5-dimethylphenyl]propane; 2,2-bis[4-(4-aminophenoxy)phenyl]-1,1,1,3,3,3-hexafluoropropane; 1,4-bis(3-aminophenoxy)benzene; 1,3-bis(3-aminophenoxy)benzene; 1,4-bis(4-aminophenoxy)benzene; 4,4′-bis(4-aminophenoxy)biphenyl; bis[4-(4-aminophenoxy)phenyl]ketone; bis[4-(4-aminophenoxy)phenyl]sulfide; bis[4-(4-amainophenoxy)phenyl]sulfoxide; bis[4-(4-aminophenoxy)phenyl]sulfone; bis[4-(3-aminophenoxy)phenyl]ether; bis[4-(4-amainophenoxy)phenyl]ether; 1,3-bis[4-(4-aminophenoxy)benzoyl]benzene; 1,3-bis[4-(3-aminophenoxy)benzoyl]benzene; 1,4-bis[4-(3-aminophenoxy)benzoyl]benzene; 4,4′-biz[(3-aminophenoxy)benzoyl]benzene; 1,1-bis[4-(3-aminophenoxy)phenyl]propane; 1,3-bis[4-(3-aminophenoxy)phenyl]propane; 3,4′-diaminodiphenylsulfide; 2,2-bis[3-(3-aminophenoxy)phenyl]-1,1,1,3,3,3-hexafluoropropane; bis[4-(3-aminophenoxy)phenyl]methane; 1,1-bis[4-(3-aminophenoxy)phenyl]ethane; 1,2-bis[4-(3-aminophenoxy)phenyl]ethane; bis[4-(3-aminophenoxy)phenyl]sulfoxide; 4,4′-bis[3-(4-aminophenozy)benzoyl]diphenylether; 4,4′-bis[3-(3-aminophenoxy)benzoyl]diphenylether; 4,4′-bis[4-(4-amino-α,α-dimethylbenzyl)phenoxy]benzophenone; 4,4′-bis[4-(4-amino-α,α-dimethylbenzyl)phenoxy]diphenylsulfone; bis[4-{4-(4-aminophenoxy)phenoxy}phenyl]sulfone; 1,4-bis[4-(4-aminophenoxy)phenoxy-α,α-dimaethylbenzyl]benzene; 1,3-bis[4-(4-aminophenozy)phenoxy-α,α-dimethylbenzyl]benzene; 1,3-bis[4-(4-amino-6-trifluoromethylphenoxy)-α,α-dimethylbenzyl]benzene; 1,3-bis[4-(4-amino-6-fluorophenoxy)-α,α-dimethylbenzyl)benzene; 1,3-bis(4-(4-amino-6-methylphenoxy)-α,α-dimethylbenzyl]benzene; 1,3-bis[4-(4-amino-6-cyanophenozy)-α,α-dimethylbenzyl]benzene; 3,3′-diamino-4,4′-diphenoxybenzophenone; 4,4′-diamino-5,5′-diphenoxybenzophenone; 3,4′-diamino-4,5′-diphenoxybenzophenone; 3,3′-diamino-4-phenoxybenzophenone; 4,4′-diamino-5-phenoxybenzophenone, 3,4′-diamino-4-phenoxybenzophenone; 3,4′-diamino-5′-phenoxybenzophenone; 3,3′-diamino-4,4′-dibiphenoxybenzophenone; 4,4′-diamino-5,5′-dibiphenoxybenzophenone; 3,4′-diamino-4,5′-dibiphenoxybenzophenone; 3,3′-diamino-4-biphenoxybenzophenone; 4,4′-diamino-5-biphenoxybenzophenone; 3,4′-diamino-4-biphenoxybenzophenone; 3,4′-diamino-5′-biphenoxybenzophenone; 1,3-bis(3-amino-4-phenoxybenzoyl)benzene; 1,4-bis(3-amino-4-phenoxybenzoyl)benzene; 1,3-bis(4-amino-5-phenoxybenzoyl)benzene; 1,4-bis(4-amino-5-phenoxybenzoyl)benzene; 1,3-bis(3-amino-4-biphenoxybenzoyl)benzene, 1,4-bis(3-amino-4-biphenoxybenzoyl)benzene; 1,3-bis(4-amino-5-biphenoxybenzoyl)benzene; 1,4-bis(4-amino-5-biphenoxybenzoyl)benzene; 2,6-bis[4-(4-amino-α,α-dimethylbenzyl)phenoxy]benzonitrile; aromatic diamines obtained by substituting a part or all of hydrogen atoms on an aromatic ring of the above-described aromatic diamines with halogen atoms; C1-3 alkyl groups or alkoxyl groups; cyano groups; or C1-3 halogenated alkyl groups or alkoxyl groups in which a part or all of hydrogen atoms of an alkyl group or alkoxyl group are substituted with halogen atoms; and the like.

Examples of the aliphatic diamines include: 1,2-diaminoethane; 1,4-diaminobutane; 1,5-diaminopentane; 1,6-diaminohexane; 1,8-diaminooctane; and the like.

Examples of the alicyclic diamines include: 1,4-diaminocyclohexane; 4,4-methylenebis(2,6-dimethylcyclohexylamine); and the like.

A total amount of the diamines except the aromatic diamines (the aliphatic diamines and the alicyclic diamines) is preferably 20% by mass or less, is more preferably 10% by mass or less, and is further preferably 5% by mass or less of a total amount of the all kinds of the diamines. In other words, an amount of the aromatic diamines is preferably 80% by mass or more, is more preferably 90% by mass or more, and is further preferably 95% by mass or more of the total amount of the all kinds of the diamines.

As tetracarboxylic acids for composing the polyamic acid, aromatic tetracarboxylic acids (including their acid anhydrides), aliphatic tetracarboxylic acids (including their acid anhydrides) and alicyclic tetracarboxylic acids (including their acid anhydrides), which are usually used for polyimide synthesis, can be used. Among them, aromatic tetracarboxylic anhydrides and alicyclic tetracarboxylic anhydrides are preferable, aromatic tetracarboxylic anhydrides are more preferable in the light of the heat resistance, and alicyclic tetracarboxylic acids are more preferable in the light of light transmittance. In the case where they are acid anhydrides, one or two anhydride structures may exist in each of their molecules, but an anhydride having two anhydride structures (dianhydride) is preferable. The tetracarboxylic acids may be used alone or in combination of two kinds or more.

Examples of the alicyclic tetracarboxylic acids include: alicyclic tetracarboxylic acids such as cyclobutanetetracarboxylic acid; 1,2,4,5-cyclohexanetetracarboxylic acid; 3,3′,4,4′-bicyclohexyltetracarboxylic acid; and their anhydrides. Among these, dianhydrides having two anhydride structures (for example, cyclobutanetetracarboxylic dianhydride, 1,2,4,5-cyclohexanetetracarboxylic dianhydride, 3,3′,4,4′-bicyclohexyltetracarboxylic dianhydride and the like) are preferable. Incidentally, the alicyclic tetracarboxylic acids may be used alone or in combination of two kinds or more.

For obtaining high transparency, an amount of the alicyclic tetracarboxylic acids is preferably 30% by mass or more, is more preferably 90% by mass or more, and is further preferably 95% by mass or more of, for example, a total amount of the ail kinds of the tetracarboxylic acids.

The aromatic tetracarboxylic acids are not limited particularly, but a pyromellitic acid residue (which has a structure derived from pyromellitic acid) is preferable, and its anhydride is more preferable. Examples of these aromatic tetracarboxylic acids include: pyromellitic dianhydride; 3,3′,4,4′-biphenyltetracarboxylic dianhydride; 4,4′-oxydiphthalic dianhydride; 3,3′,4,4′-benzophenonetetracarboxylic dianhydride; 3,3′,4,4′-diphenylsulfonetetracarboxylic dianhydride; 2,2-bis[4-(3,4-dicarboxyphenoxy)phenyl]propionic anhydride; and the like.

For obtaining high heat resistance, an amount of the aromatic tetracarboxylic acids is preferably 80% by mass or more, is more preferably 90% by mass or more, and is further preferably 95% by mass or more of, for example, the total amount of the all kinds of the tetracarboxylic acids.

The thickness of the polymer film is preferably 3 μm or more, more preferably 11 μm or more, further preferably 24 μm or more, and still more preferably 45 μm or more. The upper limit of the thickness of the polymer film is not particularly limited but is preferably 250 μm or less, more preferably 150 μm or less, and further preferably 90 μm or less for use as a flexible electronic device.

The average CTE of the polymer film at between 30° C. and 300° C. ranges preferably from −5 ppm/° C. to +20 ppm/° C., more preferably from −5 ppm/° C. to +15 ppm/° C., and further preferably from 1 ppm/° C. to +10 ppm/° C. If the CTE is within the above-described range, a difference in coefficient of linear thermal expansion from that of a general support (inorganic support) can be kept to be small, and the polymer film can be prevented from being peeled off from the inorganic support even in a process of heating. Here, CTE is a factor that represents reversible expansion and contraction with respect to temperature. The CTE of the polymer film refers to the average value of the CTE in the flow direction (MD direction) and the CTE in the width direction (TD direction) of the polymer film. The method for measuring CTE of the polymer film is as described in Examples.

The thermal contraction rate of the polymer film at between 30° C. and 500° C. is preferably ±0.9% and further preferably ±0.6%. The thermal contraction rate is a factor that represents irreversible expansion and contraction with respect to temperature.

The tensile breaking strength of the polymer film is preferably 60 MPa or more, more preferably 120 MPa or more, and further preferably 240 MPa or more. The upper limit of the tensile breaking strength is not particularly limited but is practically less than about 1000 MPa. If the tensile breaking strength is 60 MPa or more, it is possible to prevent the polymer film from breaking when being peeled off from the inorganic substrate. The tensile breaking strength of the polymer film refers to the average value of the tensile breaking strength in the flow direction (MD direction) and the tensile breaking strength in the width direction (TD direction) of the polymer film. The method for measuring the tensile breaking strength of the polymer film is as described in Examples.

The tensile breaking elongation of the polymer film is preferably 1% or more, more preferably 5% or more, and further preferably 20% or more. If the tensile breaking elongation is 1% or more, the handleability is excellent. The tensile breaking elongation of the polymer film refers to the average value of the tensile breaking elongation in the flow direction (MD direction) and the tensile breaking elongation in the width direction (TD direction) of the polymer film. The method for measuring the tensile breaking elongation of the polymer film is as described in Examples.

The tensile elasticity of the polymer film is preferably 3 GPa or more, more preferably 6 GPa or more, and further preferably 8 GPa or more. If the tensile elasticity is 3 GPa or more, the polymer film is less expanded and deformed when being peeled off from the inorganic substrate and exhibits excellent handleability. The tensile elasticity is preferably 20 GPa or less, more preferably 12 GPa or less, and further preferably 10 GPa or less. If the tensile elasticity is 20 GPa or less, the polymer film can be used as a flexible film. The tensile elasticity of the polymer film refers to the average value of the tensile elasticity in the flow direction (MD direction) and the tensile elasticity in the width direction (TD direction) of the polymer film. The method for measuring the tensile elasticity of the polymer film is as described in Examples.

Unevenness of the thickness of the polymer film is preferably 20% or less, more preferably 12% or less, further preferably 7% or less, and particularly preferably 4% or less. If the evenness of the thickness exceeds 20%, the polyimide film tends to be hardly applied to a narrow part. Incidentally, unevenness of a thickness of a film can be obtained based on a below formula from film thicknesses, which are measured at about 10 randomly extracted points of a measured film by using, for example, a contact-type film thickness meter.

Unevenness of thickness of film (%)=100×maximum film thickness−minimum film thickness)+average film thickness

The polymer film preferably has a form of being wound as a long polymer film that has a width of 300 mm or more and a length of 10 m or more at the time of its production, and more preferably has a form of a roll-type polymer film wound around a winding core. If the polymer film is wound in a roll shape, it can be easily transported in the form of a heat-resistant polymer film wound in a roll shape.

In order to secure handleability and productivity of the polymer film, a lubricant (particles) having a particle size of about 10 to 1000 nm is preferably added to be contained in the polymer film in an amount of about 0.03% to 3% by mass so as to provide fine ruggedness onto the surface of the polymer film, thereby securing its slipperiness.

### <Polyvalent Amine Compound Layer>

The polyvalent amine compound layer is a layer formed using a polyvalent amine compound. The polyvalent amine compound layer may be a layer formed by applying a polyvalent amine compound to an inorganic substrate or a layer formed by applying a polyvalent amine compound to a polymer film. The details of the method for forming the polyvalent amine compound layer will be described later in the section of the method for producing a laminate.

In the present specification, the polyvalent amine compound layer is a “polyvalent amine compound layer” if there is a portion having more nitrogen atoms than the polymer film. In other words, it means that a “polyvalent amine compound layer” exists if there is a portion having more nitrogen atoms than the polymer film even if the clear boundary line between the polymer film and the polyvalent amine compound layer is unclear.

The presence or absence of a polyvalent amine compound layer is determined by analysis of nitrogen atoms using an X-ray photoelectron spectrometer (ESCA). Specifically, the nitrogen content A on the surface of the spot where the polyvalent amine compound layer is considered to exist is measured. Next, argon etching is performed to the central portion in the thickness direction of the polymer film, and then the nitrogen content B at that portion is measured. The nitrogen content B and the nitrogen content A are then compared with each other, and it is determined that the polyvalent amine compound layer exists if the nitrogen content A is larger than the nitrogen content B by 0.5 atomic % or more.

In a case where the polyvalent amine compound layer is formed by applying the polyvalent amine compound to the polymer film, the polymer film may be surface-activated before being surface-treated with the polyvalent amine compound. The surface activation treatment in the present specification is dry or wet surface treatment. Examples of the dry surface treatment; include vacuum plasma treatment, normal pressure plasma treatment, treatment of irradiating the surface with active energy rays such as ultraviolet rays, electron beams, and X rays, corona treatment, flame treatment, Itro treatment and the like. Examples of the wet surface treatment include treatment of bringing the surface of the polymer film into contact with an acid or alkali solution.

A plurality of the surface activation treatments may be performed in combination. In the surface activation treatment, the surface of the polymer film is cleaned, and a more active functional group is generated. The thus generated functional group is bound with the polyvalent amine compound by a hydrogen bond, a chemical reaction or the like, and the polymer film and the polyvalent amine compound can be firmly adhered to each other.

### <Inorganic Substrate>

The inorganic substrate may be a plate-type substrate which can be used as a substrate made of an inorganic substance, and examples thereof include those mainly composed of glass plates, ceramic plates, semiconductor wafers, metals and the like and those in which these glass plates, ceramic plates, semiconductor wafers, and metals are laminated, those in which these are dispersed, and those in which fibers of these are contained as the composite of these.

Examples of the glass plates include quartz glass, high silicate glass (96% silica), soda lime glass, lead glass, aluminoborosilicate glass, and borosilicate glass (Pyrex (registered trademark)), borosilicate glass (alkali free), borosilicate glass (microsheet), aluminosilicate glass and the like. Among these, those having a coefficient of linear thermal expansion of 5 ppm/K or less are desirable, and in the case of a commercially available product, “Corning (registered trademark) 7059”, “Corning (registered trademark) 1737”, and “EAGLE” produced by Corning Inc., “AN100” produced by AGC Inc., “OA10” produced, by Nippon Electric Glass Co., Ltd., “AF32” produced by SCHOTT AG, and the like that are glass for liquid crystals are desirable.

The semiconductor wafer is not particularly limited, but examples thereof include a silicon wafer and wafers of germanium, silicon-germanium, gallium-arsenide, aluminum-gallium-indium, nitrogen-phosphorus-arsenic-antimony, SiC, InP (indium phosphide), InGaAs, GaInNAs, LT, LN, ZnO (zinc oxide), CdTe (cadmium telluride), ZnSe (zinc selenide) and the like. Among these, the wafer preferably used is a silicon wafer, and a mirror-polished silicon wafer having a size of 8 inches or more is particularly preferable.

The metals include single element metals such as W, Mo, Ft, Fe, Ni, and Au, alloys such as Inconel, Monel, Nimonic, carbon-copper, Fe—Ni-based Invar alloy, and Super Invar alloy, and the like. Multilayer metal plates formed by adding another metal layer or a ceramic layer to these metals are also included. In this case, if the overall coefficient of linear thermal expansion (CTE) with the additional layer is low, Cu, Al and the like are also used in the main metal layer. The metals used as the addition metal layer is not limited as long as they are those that strengthen the adhesion with the polymer film, those that have characteristics that there is no diffusion and the chemical resistance and heat resistance are favorable, but suitable examples thereof include Cr, Ni, TiN, and Mo-containing Cu.

It is desirable that the flat portion of the inorganic substrate is sufficiently flat. Specifically, the P-V value of the surface roughness is 50 nm or less, more preferably 20 nm or less, and further preferably 5 nm or less. If the surface is coarser than this, the peel strength between the polymer film layer and the inorganic substrate may be insufficient.

The thickness of the inorganic substrate is not particularly limited, but a thickness of 10 mm or less is preferable, a thickness of 3 mm or less is more preferable, and a thickness of 1.3 mm or less is further preferable from the viewpoint of handleability. The lower limit of the thickness is not particularly limited but is preferably 0.07 mm or more, more preferably 0.15 mm or more, and further preferably 0.3 mm or more.

### <Method for Producing Laminate>

The laminate can be produced by first forming a polyvalent amine compound layer on an inorganic substrate and then bonding a polymer film to the polyvalent amine compound layer. Hereinafter, this production method is also referred to as the method for producing a laminate according to the first embodiment.

The laminate can also be produced by first forming a polyvalent amine compound layer on a polymer film and then bonding an inorganic substrate to the polyvalent amine compound layer. Hereinafter, this production method is also referred to as the method for producing a laminate according to the second embodiment.

### <Method for Producing Laminate According to First Embodiment>

The method for producing a laminate according to the first embodiment includes at least:

a step A of forming a polyvalent amine compound layer on an inorganic substrate; and

a step B of bonding a heat-resistant polymer film to the polyvalent amine compound layer.

### <Step A>

In step A, a polyvalent amine compound layer is formed by applying a polyvalent amine compound to an inorganic substrate.

### <Polyvalent Amine Compound>

The polyvalent amine compound is not particularly limited as long as it is a compound having two or more amines. In the present specification, the amine refers to a primary amine. In other words, in the present specification, in the case of counting the number of amines contained in a polyvalent amine compound, the number of primary amines is counted. For example, triethylenetetramine has two primary amines and two secondary amines and is classified as a diamine but not a tetramine since triethylenetetramine has two primary amines.

Specific examples of the polyvalent amine compound include hydrocarbon-based diamines such as 1,2-ethanediamine (ethylenediamine), 1,3-propanediamine, 2-methyl-2-propyl-1,3-propanediamine, 1,2-propanediamine, 2-methyl-1,3-propanediamine, 1,4-butanediamine (putrescine, tetramethylenediamine (TMDA)), 2,3-dimethyl-1,4-butanediamine, 1,3-butanediamine, 1,2-butandiamine, 2-ethyl-1,4-butanediamine, 2-methyl-1,4-butanediamine, 1,5-pentanediamine, 2-methyl-1,5-pentanediamine (2-methyl1,5-diaminopentane), 3-methyl-1,5-pentanediamine, 3,3-dimethyl-1,5-pentanediamine, 1,4-pentanediamine, 2-methyl-1,4-pentanediamine, 3-methyl-1,4-pentanediamine, 1,3-pentanediamine, 4,4-dimethyl-1,3-pentanediamine, 2,2,4-trimethyl-1,3-pentanediamine, 1,2-pentanediamine, 4-methyl-1,2-pentanediamine, 4-ethyl-1,2-pentanediamine, 3-methyl-1,2-pentanediamine, 3-ethyl-1,2-pentanediamine, 2-methyl-1,3-pentanediamine, 4-methyl-1,3-pentanediamine, 1,6-hexanediamine (hexamethylenediamine), 3-methyl-1,6-hexanediamine, 3,3-dimethyl-1,6-hexanediamine, 3-ethyl-1,6-hexanediamine, 1,5-hexanediamine, 1,4-hexanediamine, 1,3-hexanediamine, 1,2-hexanediamine, 2,5-hexanediamine, 2,5-dimethyl-2,5-hexanediamine, 2,4-hexanediamine, 2-methyl-2,4-hexanediamine, 2,3-hexanediamine, 5-methyl-2,3-hexanediamine, 3,4-hexanediamine, 1,7-heptanediamine, 2-methyl-1,7-heptanediamine, 1,6-heptanediamine, 1,5-heptanediamine, 1,4-heptanediamine, 1,3-heptanediamine, 1,2-heptanediamine, 2,6-heptanediamine, 2,5-heptanediamine, 2,4-heptanediamine, 2,3-heptanediamine, 3,5-heptanediamine, 3,4-heptanediamine, 1,8-octanediamine, 1,7-octanediamine, 1,6-octanediamine, 1,5-octanediamine, 1,4-octanediamine, 1,3-octanediamine, 1,2-octanediamine, 2,7-octanediamine, 2,7-dimethyl-2,7-octanediamine, 2,6-octanediamine, 2,5-octanediamine, 2,4-octanediamine, 2,3-octanediamine, 3,6-octanediamine, 3,5-octanediamine, 3,4-octanediamine, diethylenetriamine, triethylenetetramine, and 1,4,8-triazaoctane; and hydrocarbon-based triamines such as 1,3,5-pentanetriamine and 1,4,7-heptanetriamine.

Other specific examples of the polyvalent amine compound include aromatic diamines and alicyclic diamines. Examples thereof include pyridine-2,4-diamine, N2,N6-dimethyl-2,6 pyridinediamine, 2-pyridineamine, 2,3-pyridinediamine, 4,6-pyrimidinediamine, 2,4,6-pyrimidinetriamine, 2-amino-4-pyridinemethaneamine, 2,3-pyrazinediamine, 2,5-pyridinediamine 1,2-cyclohezanediamine, 1-methyl-1,2-cyclohexanediamine, 3-methyl-1,2-cyclohexanediamine, 4-methyl-1,2-cyclohexanediamine, 1,2-diamino-4-cyclohexene, 1,3-cyclohezanediamine, 2-methyl-1,3-cyclohexanediamine, 1,4-cyclohexanediamine, 1,2,3-cyclohexanetriamine, 1,2-cyclopentanediamine, 1,3-cyclopentanediamine, 4,4′-methylenebis(cyclohexylamine), 4,5,6-pyrimidinetriamine, 2,4,6-triaminopyrimidine, and 3,3′-diaminobenzidine.

Among the polyvalent amine compounds, those having a molecular weight of 300 or less are preferable, those having a molecular weight of 250 or less are more preferable, and those having a molecular weight of 200 or less are more preferable, if the molecular weight of the polyvalent amine compound is 300 or less, there are a large number of compounds in a liquid state at room temperature, and these compounds can be conveniently used in the gas phase coating method.

Among the polyvalent amine compounds, a diamine compound is preferable. If the polyvalent amine compound is a diamine compound, the adhesive strength (peel strength) of the polymer film with the inorganic substrate is more favorable. Even if the laminate is exposed to a high temperature (for example, 500° C. for 1 hour), it is possible to further suppress an increase in peel strength.

Among the polyvalent amine compounds, a branched aliphatic polyvalent amine compound is preferable. If the polyvalent amine compound is a branched aliphatic polyvalent amine compound, the branched aliphatic polyvalent amine compounds generally have a lower boiling point than straight-chain aliphatic polyvalent amine compounds even though both of these have the same number of carbon atoms, and film treatment by a gas phase coating method or the like can be more conveniently performed.

As a method for applying the polyvalent amine compound, a method for applying a polyvalent amine compound solution to the inorganic substrate, a gas phase coating method, and the like can be used. The polyvalent amine compound may be applied to either surface or both surfaces of the polymer film.

As the method for applying the polyvalent amine compound solution, it is possible to use a solution of the polyvalent amine compound diluted with a solvent such as an alcohol and to appropriately use conventionally known solution application means such as spin coating method, curtain coating method, dip coating method, slit die coating method, gravure coating method, bar coating method, comma coating method, applicator method, screen printing method, and spray coating method.

As a gas phase coating method, specifically the polyvalent amine compound layer is formed by exposing the inorganic substrate to the vapor of a polyvalent amine compound, namely, a polyvalent amine compound in a substantially gaseous state. The vapor of a polyvalent amine compound can be obtained by heating the polyvalent amine compound in a liquid state to a temperature from room temperature (25° C.) to about the boiling point of the polyvalent amine compound.

The environment for heating the polyvalent amine compound may be under any of applied pressure, normal pressure, or reduced pressure but is preferably under normal pressure or reduced pressure in the case of promoting the vaporization of the polyvalent amine compound.

The time for exposing the polymer film to the polyvalent amine compound is not particularly limited, but is preferably within 20 hours, more preferably within 60 minutes, further preferably within 15 minutes, and most preferably within 1 minute.

The temperature of the polymer film during exposure of the polymer film to the polyvalent amine compound is preferably controlled to an appropriate temperature between −50° C. and 200° C. depending on the kind of the polyvalent amine compound and the desired degree of surface treatment.

As a gas phase coating method, there is also a method in which the polyvalent amine compound is vaporized by allowing clean dry air to bubble in the polyvalent amine compound in a liquid state.

### <Step B>

In step B, a polymer film is bonded to the polyvalent amine compound layer. Specifically, the surface of the polyvalent amine compound layer formed on the inorganic substrate and the polymer film are pressure-heated to be bonded to each other.

In the pressure and heat treatment, for example, press, lamination, roll lamination or the like may be carried out while performing heating in the atmosphere at the atmospheric pressure or in vacuum. Further, a method of applying pressure and heat to the laminate, while it is in a flexible bag, can also be adopted. In the light of the improvement of the productivity and the reduction of processing cost, which is brought from the high productivity, press or roll lamination is preferably carried out in the atmosphere, and in particular, a method using a roll (roll lamination or the like) is preferable.

Pressure during the pressure and heat treatment ranges preferably from 1 MPa to 20 MPa and more preferably from 3 MPa to 10 MPa. If the pressure is 20 MPa or less, it is possible to suppress damage to the inorganic substrate. If the pressure is 1 MPa or more, it is possible to prevent the generation of a portion that does not closely adhere and insufficient adhesion. The temperature during the pressure and heat treatment ranges preferably from 150° C. to 400° C. and more preferably from 250° C. to 350° C. In a case where the polymer film is a polyimide film, the polyimide film may be damaged if the temperature is too high and the cohesive strength tends to be weak if the temperature is too low.

Further, the pressure and heat treatment can be carried out in the atmosphere at the atmospheric pressure as described above but is preferably carried out in vacuum for obtaining stable peel strength of full surfaces. At this time, as a degree of the vacuum, a degree of vacuum obtained by an ordinary oil-sealed rotary pump, that is, about 10 Torr or less is sufficient.

As an apparatus that can be used for the pressure and heat treatment, for example, an “11FD” produced by Imoto Machinery Co., Ltd. or the like can be used for pressing in vacuum, and, for example, an “MVLP” produced by MEIKI CO., LTD, or the like can be used for vacuum lamination using a roll film laminator in vacuum or a film laminator for evacuating the air and then applying pressure at once to a full surface of glass by a thin rubber film.

As the pressure and heat treatment, a pressure process and a heat process can be carried out separately. In this case, firstly, pressure (preferably about 0.2 MPa to about 50 MPa) is applied to the polymer films and the inorganic substrate(s) at a comparatively low temperature (for example, at less than 120° C., and more preferably at 95° C. or less) so as to secure their cohesion, and then, the polymer films and the inorganic substrate(s) are heated at low pressure (preferably at less than 0.2 MPa, and more preferably at 0.1 MPa or less) or normal pressure at a comparatively high temperature (for example, at 120° C. or more, more preferably at 120° C. to 250° C., and further preferably at 150° C. to 230° C.), so that a chemical reaction in the cohesion interface can be promoted, whereby the polymer films and the inorganic substrate(s) can be laminated.

It is thus possible to obtain a laminate in which an inorganic substrate and a polymer film are bended to each other.

### <Method for Producing Laminate According to Second Embodiment

The method for producing a laminate according to the second embodiment includes at least:

a step X of forming a polyvalent amine compound layer on a polymer film; and

a step Y of bonding an inorganic substrate to the polyvalent amine compound layer.

### <Step X>

In step X, a polyvalent amine compound layer is formed by applying a polyvalent amine compound to a polymer film. The method for forming a polyvalent amine compound on a polymer film can be similar to the method for forming a polyvalent amine compound on an inorganic substrate. Since the details have been described in the section of the first embodiment, the description thereof will be omitted here.

### <Step Y>

In step Y, an inorganic substrate is bonded to the polyvalent amine compound layer. Specifically, the surface of the polyvalent amine compound layer formed on the polymer film and the inorganic substrate are pressure-heated to be bonded to each other. The bonding conditions (pressure and heat treatment conditions) can be similar to those in the first embodiment.

It is thus possible to obtain a laminate in which an inorganic substrate and a polymer film are bonded to each other by the method for producing a laminate according to the second embodiment as well.

### <Other Methods for Producing Laminate>

A laminate may be produced by forming the polyvalent amine compound layer on the inorganic substrate as well as forming the polyvalent amine compound layer on the polymer film and bonding the two to each other with the polyvalent amine compound layers as a bonding surface.

### <Method for Producing Flexible Electronic Device>

If the laminate is used, a flexible electronic device can be fabricated by forming an electronic device on the polymer film of the laminate using existing equipment and processes for electronic device fabrication and peeling off the electronic device from the laminate together with the polymer film.

In the present specification, the electronic device refers to a wiring board which carries out electrical wiring and has a single-sided, double-sided, or multi-layered structure, electronic circuits including active devices such as transistors and diodes and passive devices such as resistors, capacitors, and inductors, sensor elements which sense pressure, temperature, light, humidity and the like, biosensor elements, light emitting elements, image display elements such as liquid crystal displays, electrophoresis displays, and self-luminous displays, wireless and wired communication elements, arithmetic elements, storage elements, MEMS elements, solar cells, thin film transistors, and the like.

In the method for producing a device structure in the present specification, a device is formed on a polymer film of a laminate fabricated by the above-described method and then the polymer film is peeled off from the inorganic substrate.

The method for peeling off the polymer film with the device from the inorganic substrate is not particularly limited, but a method in which the polymer film with the device is stripped off from the end with tweezers and the like, a method in which a cut is made into the polymer film, a pressure sensitive adhesive tape is pasted to one side of the cut portion, and then the polymer film is stripped off from the tape portion, a method in which one side of the cut portion of the polymer film is vacuum-adsorbed and then stripped off from that portion, and the like can be employed. If the cut portion of the polymer film is bent with a small curvature during peeling off, stress may be applied to the device at that portion and the device may be destroyed, and it is thus desirable to peel off the polymer film in the state of having a curvature as large as possible. For example, it is desirable to strip off the polymer film while winding the polymer film on a roll having a large curvature or to strip off the polymer film by using a machine having a configuration in which the roll having a large curvature is located at the peeling portion.

As the method for making a cut into the polymer film, there are a method in which the polymer film is cut with a cutting tool such as a cutter, a method in which the polymer film is cut by scanning a laser and the laminate relative to each other, a method in which the polymer film is cut by scanning a water jet and the laminate relative to each other, a method in which the polymer film is cut while being cut a little to the glass layer by a dicing apparatus for a semiconductor chip, and the like, but the method is not particularly limited. For example, when employing the above-described methods, it is also possible to appropriately employ a technique in which ultrasonic waves are superimposed on the cutting tool or a reciprocating motion, a vertical motion and the like are further added to improve the cutting performance.

It is also useful to stick another reinforcing base material to the portion to be peeled off in advance and peel off the polymer film together with the reinforcing base material. In a case where the flexible electronic device to be peeled off is the backplane of a display device, it is also possible to obtain a flexible display device by sticking the frontplane of the display device in advance, integrating these on an inorganic substrate, and then peeling off these two at the same time.

### EXAMPLES

Hereinafter, the present invention will be described in detail with reference to Examples, but the present invention is not limited to the following Examples as long as the gist of the present invention is not exceeded.

### Production Example 1 (Production of Polyamic Acid Solution A)

The inside of a reaction vessel equipped with a nitrogen introducing tube, a thermometer, and a stirring bar was substituted with nitrogen, and then 223 parts by mass of 5-amino-2-(p-aminophenyl)benzoxazole (DAMBO) and 4416 parts by mass of N,N-dimethylacetamide were added into the reaction vessel and completely dissolved. Next, SNOWTEX (DMAC-ST30, produced by Nissan Chemical Corporation) in which colloidal silica (average particle size: 0.08 μm) was dispersed in dimethylacetamide was added to the solution together with 217 parts by mass of pyromellitic dianhydride (PMDA) so that colloidal silica was 0.1% by mass with respect to the total amount of polymer solids in the polyamic acid solution A, and the mixture was stirred at a reaction temperature of 25° C. for 24 hours, thereby obtaining a brown and viscous polyamic acid solution A.

### Production Example 2 (Production of Polyamic Acid Solution B)

The inside of a reaction vessel equipped with a nitrogen introducing tube, a thermometer, and a stirring bar was substituted with nitrogen, and then 393 parts by mass of 3,3′,4,4′-biphenyltetracarboxylic dianhydride (BPDA) and 4600 parts by mass of N,N-dimethylacetamide were added into the reaction vessel and thoroughly stirred so as to be uniform. Next, BPDA and 147 parts by mass of para-dianiline (PDA) were added into the reaction vessel, and SNOWTEX (DMAC-ST30, produced by Nissan Chemical Corporation) in which colloidal silica (average particle size: 0.08 μm) was dispersed in dimethylacetamide was further added to the mixture so that colloidal silica was 0.7% by mass with respect to the total amount of polymer solids in the polyamic acid solution B, and the mixture was stirred at a reaction temperature of 25° C. for 24 hours, thereby obtaining a brown and viscous polyamic acid solution B.

### Production Example 3 (Production of Polyamic Acid Solution C)

The inside of a reaction vessel equipped with a nitrogen introducing tube, a thermometer, and a stirring bar was substituted with nitrogen, and then pyromellitic anhydride (PMDA) and 4,4′diaminodiphenyl ether (ODA) were added into the reaction vessel in equivalent amounts and dissolved in N,N-dimethylacetamide, SNOWTEX (DMAC-ST30, produced by Nissan Chemical Corporation) in which colloidal silica (average particle size: 0.08 μm) was dispersed in dimethylacetamide was added to the solution so that colloidal silica was 0.7% by mass with respect to the total amount of polymer solids in the polyamic acid solution C, and the mixture was stirred at a reaction temperature of 25° C. for 24 hours, thereby obtaining a brown and viscous polyamic acid solution C.

### Production Example 4 (Fabrication of Polyimide Film 15)

The polyamic acid solution A obtained in Production Example 1 was applied (coating width: 1240 mm) to a mirror-finished endless continuous belt made of stainless steel using a die coater, and dried at 90° C. to 115° C. for 10 minutes. The polyamic acid film which was self-supporting after drying was peeled off from the support and both ends thereof were cut, thereby obtaining a green film.

The obtained green film was conveyed by a pin tenter so that the final pin sheet interval was 1140 mm, and subjected to heat treatment at 170° C. for 2 minutes as the first stage, at 230° C. for 2 minutes as the second stage, and at 485° C. for 6 minutes as the third stage to allow the imidization reaction to proceed. Thereafter, the film was cooled to room temperature in 2 minutes, and the portions of both ends of the film having poor flatness were cut off with a slitter, and the film was then rolled up into a roll, thereby obtaining a brown polyimide film 1.

### Production Example 5 (Fabrication of Polyimide Film 2)

A polyimide film 2 was obtained in the same manner as in Production Example 4 except that the polyamic acid solution B obtained in Production Example 2 was used.

### Production Example 6 (Fabrication of Polyimide Film 3)

A polyimide film 3 was obtained in the same manner as in Production Example 4 except that the polyamic acid solution C obtained in Production Example 3 was used.

### <Measurement of Thickness of Polyimide Film>

The thickness of the polyimide films 1 to 3 was measured by a micrometer (Millitron 1245D produced by Feinpruf GmbH). The results are shown in Table 1.

### <Tensile Elasticity, Tensile Breaking Strength, and Tensile Breaking Elongation of Polyimide Film>

The polyimide films 1 to 3 were cut into a strip shape of 100 mm×10 ram respectively in a flow direction (MD direction) and in a width direction (TD direction), thereby producing test pieces. Tensile elasticity, tensile breaking strength and tensile breaking elongation of the test piece in the MD direction and the TD direction were measured respectively at tensile speed of 50 mm/minute and a distance between chucks of 40 mm by a tensile tester (Autograph®, Trade Name of AG-5000A, produced by Shimadzu Corporation). The results are shown in Table 1.

### <Coefficient of Linear Thermal Expansion (CTE) of Polyimide Film>

Expansion/contraction rates of the polyimide films 1 to 3 in a flow direction (MD direction) and a width direction (TD direction) were respectively measured in below-described conditions, and expansion/contraction rates over time were measured at every 15° C. such as 30° C. to 45° C., 45° C. to 60° C., etc., up to 300° C., thereby calculating an average value of the all measured values as a CTE. The results are shown in Table 1.

Device name: TMA40003 produced by MAC Science Corporation

Length of sample: 20 mm

Width of sample: 2 mm

Start temperature in rising temperature: 25° C.

End temperature in rising temperature: 400° C.

Rising rate of temperature: 5° C./min

Atmosphere: Argon

TABLE 1

| Polyimide film | | | 1 | 2 | 3 |
|---|---|---|---|---|---|
| Polyamic acid solution | | | A | B | C |
| Thickness | | μm | 38 | 38 | 38 |
| Tensile | MD | MPa | 450 | 511 | 339 |
| breaking | TD | | 443 | 535 | 371 |
| strength | Average | | 446.5 | 523 | 355 |
| Tensile | MD | GPa | 7.1 | 8.4 | 3.2 |
| elasticity | TD | | 7.1 | 8.3 | 4.1 |
| | Average | | 7.1 | 8.35 | 3.65 |
| Tensile | MD | % | 33.4 | 38.7 | 75.6 |
| breaking | TD | | 36.7 | 41.6 | 87.7 |
| elongation | Average | | 35.05 | 40.25 | 81.65 |
| Coefficient of | MD | ppm/° C. | 2.2 | 9.1 | 14 |
| linear thermal | TD | | 2.8 | 6.9 | 16 |
| expansion (CTE) | Average | | 2.5 | 9 | 15 |

### Example 1

An amine diluted solution diluted with isopropanol so as to contain tetramethylenediamine (TMDA) as an amine compound at 0.4% by mass was prepared. A glass substrate (OA10G glass (produced by Nippon Electric Glass Co., Ltd.) with a thickness of 0.7 mm cut into a site of 0.100 mm*100 mm) was installed on a spin coater (MSC-500S, produced by JAPANCREATE, LTD.). The amine diluted solution was dropped onto the glass substrate, spread over the entire surface of the glass substrate by rotating the spin coater at 500 rpm, and then shaken off and dried by rotating the spin coater at 2000 rpm. The rotation was stopped in 30 seconds after the dropping. A polyvalent amine compound layer was thus formed on a glass substrate. This stop corresponds to step A of the present invention.

Next, the polyimide film 1 (size: 70 mm*70 mm) obtained in Production Example 4 was bonded on the polyvalent amine compound layer, thereby obtaining a laminate. A laminator manufactured by MCK CO., LTD. was used for bonding, and the bonding conditions were pressure: 0.7 MPa, temperature: 22° C., humidity: 55% RH, and lamination speed: 50 mm/sec. The thickness of the obtained polyvalent amine compound layer is as shown in Table 2. The thickness of the polyvalent amine compound layer was determined by partially masking the glass to form a step and observing the polyvalent amine compound layer under an atomic force microscope (AFM).

### Example 2

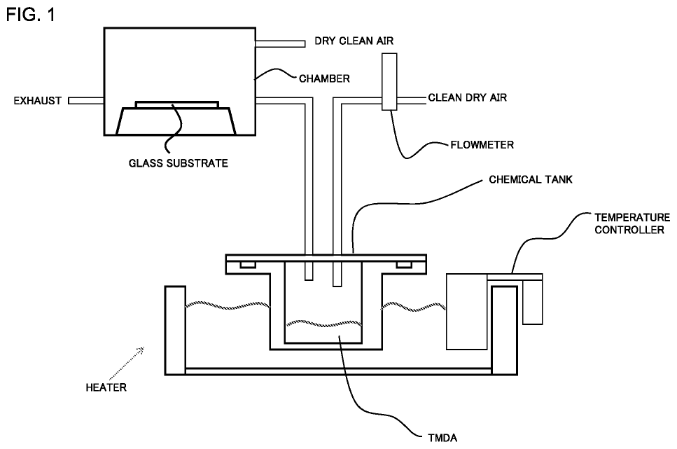

A laminate was obtained in the same manner as in Example 1 except that the method for applying tetramethylenediamine to the glass substrate was changed to gas phase coating. Specifically, the application of tetramethylenediamine to the glass substrate was carried out using the experimental apparatus illustrated in FIG. 1. FIG. 1 is a schematic view of an experimental apparatus for applying a polyvalent amine compound to a glass substrate. Hexamethylenediamine (TMDA) was placed in a 1 L chemical tank by 150 g, and the outer water bath was warmed to 60° C. The vapor that came out was sent to the chamber together with clean dry air. The gas flow rate was set to 30 L/min and the substrate temperature was set to 40° C. The temperature of clean dry air was 23° C. and the humidity thereof was 1.2% RH. Since the exhaust is connected to the exhaust port at a negative pressure, it is confirmed by the differential pressure gauge that the chamber has a negative pressure of about 10 Pa. The thickness of the obtained polyvalent amine compound layer is as shown in Table 2.

### Example 3

A laminate was obtained in the same manner as in Example 1 except that the method for applying tetramethylenediamine to the glass substrate was changed to spray coating. Specifically, the application of tetramethylenediamine to the glass substrate was carried out using a gravity spray gun. As the amine diluted solution for spraying, tetramethylenediamine diluted to 0.1% with isopropyl alcohol was used. The thickness of the obtained polyvalent amine compound layer is as shown in Table 2.

### Example 4

A laminate was obtained in the same manner as in Example 1 except that the polyvalent amine compound was changed from tetramethylenediamine to hexamethylenediamine (HMDA). The thickness of the obtained polyvalent amine compound layer is as shown in Table 2.

### Example 5

A laminate was obtained in the same manner as in Example 2 except that the polyvalent amine compound was changed from tetramethylenediamine to hexamethylenediamine (HMDA). The thickness of the obtained polyvalent amine compound layer is as shown in Table 2.

### Example 6

A laminate was obtained in the same manner as in Example 3 except that the polyvalent amine compound was changed from tetramethylenediamine to hexamethylenediamine (HMDA). The thickness of the obtained polyvalent amine compound layer is as shown in Table 2.

### Example 7

A laminate was obtained in the same manner as in Example 1 except that the polyvalent amine compound was changed from tetramethylenediamine to ethylenediamine (EDA). The thickness of the obtained polyvalent amine compound layer is as shown in Table 3.

### Example 8

A laminate was obtained in the same manner as in Example 2 except that the polyvalent amine compound was changed from tetramethylenediamine to diethylenetriamine (DETA). At this time, 50 g of diethylenetriamine was placed in the chemical tank, and the temperature of the outer water bath was set to 40° C. The thickness of the obtained polyvalent amine compound layer is as shown in Table 3.

### Example 9

A laminate was obtained in the same manner as in Example 3 except that the polyvalent amine compound was changed from tetramethylenediamine to triethylenetriamine (TETA). The thickness of the obtained polyvalent amine compound layer is as shown in Table 3.

### Example 10

A laminate was obtained in the same manner as in Example 1 except that the substrate was changed from a glass substrate to a silicon wafer (dummy grade 4-inch wafer). The thickness of the obtained polyvalent amine compound laver is as shown in Table 3.

### Example 11

A laminate was obtained in the same manner as in Example 2 except that the substrate was changed from a glass substrate to a silicon wafer (dummy grade 4-inch wafer). The thickness of the obtained polyvalent amine compound layer is as shown in Table 3.

### Example 12

A laminate was obtained in the same manner as in Example 3 except that the substrate was changed from a glass substrate to a silicon wafer (dummy grade 4-inch wafer). The thickness of the obtained polyvalent amine compound layer is as shown in Table 3.

### Example 13

A laminate was obtained in the same manner as in Example 4 except that the substrate was changed from, a glass substrate to a silicon wafer (dummy grade 4-inch wafer). The thickness of the obtained polyvalent amine compound layer is as shown in Table 4.

### Example 14

A laminate was obtained in the same manner as in Example 5 except that the substrate was changed from a glass substrate to a silicon wafer (dummy grade 4-inch wafer). The thickness of the obtained polyvalent amine compound layer is as shown in Table 4.

### Example 15

A laminate was obtained in the same manner as in Example 6 except that the substrate was changed from a glass substrate to a silicon wafer (dummy grade 4-inch wafer). The thickness of the obtained polyvalent amine compound layer is as shown in Table 4.

### Example 16

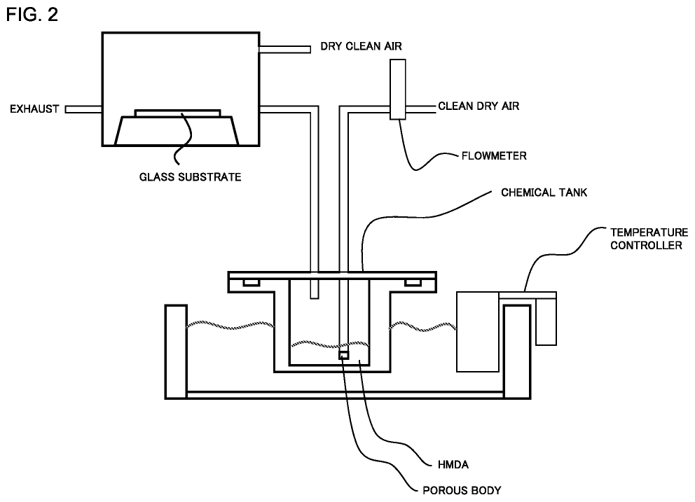

A laminate was obtained in the same manner as in Example 5 except that the substrate was changed from a glass substrate to a silicon wafer (dummy grade 4-inch wafer) and the coating method of the polyvalent amine compound layer was changed to bubbling. Specifically, the application of hexamethylenediamine to the glass substrate was carried out using the experimental apparatus illustrated in FIG. 2. FIG. 2 is a schematic view of an experimental apparatus for applying a polyvalent amine compound to a glass substrate. Hexamethylenediamine was placed in a 1 L chemical tank by 150 g, and the temperature of the outer water bath was set to 20° C. Thereafter, clean dry air allowed to bubble in hexamethylenediamine was sent to the chamber via a porous body. The gas flow rate was set to 30 L/min and the substrate temperature was set to 25° C. The temperature of clean dry air was 23° C. and the humidity thereof was 1.2% RH. The thickness of the obtained polyvalent amine compound layer is as shown in Table 4.

### Example 17

A laminate was obtained in the same manner as in Example 2 except that the heat-resistant polymer film was changed from the polyimide film 1 to the polyimide film 2. The thickness of the obtained polyvalent amine compound layer is as shown, in Table 4.

### Example 18

A laminate was obtained in the same manner as in Example 6 except that the heat-resistant polymer film was changed from the polyimide film 1 to the polyimide film 2. The thickness of the obtained polyvalent amine compound layer is as shown in Table 4.

### Example 19

A laminate was obtained in the same manner as in Example 14 except that the heat-resistant polymer film was changed from the polyimide film 1 to the polyimide film 2. The thickness of the obtained polyvalent amine compound layer is as shown in Table 5.

### Example 20

A laminate was obtained in the same manner as in Example 15 except that the heat-resistant polymer film was changed from the polyimide film 1 to the polyimide film 2. The thickness of the obtained polyvalent amine compound layer is as shown in Table 5.

### Example 21

A laminate was obtained in the same manner as in Example 2 except that the heat-resistant polymer film was changed from the polyimide film 1 to the polyimide film 5. The thickness of the obtained polyvalent amine compound layer is as shown in Table 5.

### Example 22

A laminate was obtained in the same manner as in Example 3 except that the heat-resistant polymer film was changed from the polyimide film 1 to the polyimide film 3. The thickness of the obtained polyvalent amine compound layer is as shown in Table 5.

### Example 23

A laminate was obtained in the same manner as in Example 14 except that the heat-resistant polymer film was changed from the polyimide film 1 to the polyimide film 3. The thickness of the obtained polyvalent amine compound layer is as shown in Table 5.

### Example 24

A laminate was obtained in the same manner as in Example 15 except that the heat-resistant polymer film was changed from the polyimide film 1 to the polyimide film 3. The thickness of the obtained polyvalent amine compound layer is as shown in Table 5.

### Comparative Example 1

A laminate was obtained in the same manner as in Example 2 except that the polyvalent amine compound was changed from tetramethylenediamine to 3-aminopropyltriethozysilane (APS). At this time, the temperature of the outer water bath was set to 42° C. The thickness of the obtained polyvalent amine compound layer is as shown in Table 6.

### Comparative Example 2

A laminate was obtained in the same manner as in Example 22 except that the polyvalent amine compound was changed from tetramethylenediamine to 3-aminopropyltriethoxysilane (APS). The thickness of the obtained polyvalent amine compound layer is as shown in Table 6.

### Comparative Example 3

A laminate was obtained in the same manner as in Example 11 except that the polyvalent amine compound was changed from tetramethylenediamine to N-2-(aminoethyl)-3-aminopropyltrimethoxysilane (AEAPS). The thickness of the obtained polyvalent amine compound layer is as shown in Table 6.

### Comparative Example 4

A laminate was obtained in the same manner as in Example 1 except that the polyvalent amine compound was not applied. The thickness of the obtained polyvalent amine compound layer is as shown in Table 6.

### <Measurement of 90° Initial Peel Strength>

The laminates obtained in the above-described fabrication of laminate were heat-treated at 200° C. for 1 hour in an atmospheric ambience. Thereafter, the 90° initial peel strength between the inorganic substrate (glass substrate or silicon wafer) and the polyimide film was measured. The results are shown in Tables 2 to 6.

The measurement conditions for 90° initial peel strength are as follows.

The film is peeled off from the inorganic substrate at an angle of 90°.

The measurement is performed 5 times and the average value thereof is taken as the measured value.

Measuring device: Autograph AG-IS produced by Shimadzu Corporation

Measured temperature: Room temperature (25° C.)

Peeling speed: 100 mm/min

Ambience: Atmosphere

Width of measured sample: 2.5 cm

<Measurement of 90° Peel Strength after Heating at 500° C. for 1 Hour>

The laminates obtained in the above-described fabrication of laminate were heat-treated at 200° C. for 1 hour in an atmospheric ambience. The laminates were further heated at 500° C. for 1 hour in a nitrogen ambience. Thereafter, the 90° peel strength between the inorganic substrate and the polyimide film was measured. The results are shown in Tables 2 to 6. The measurement conditions for 90° peel strength after heating at 500° C. for 1 hour were similar to those for the 90° initial peel strength.

### <Observation of Fogging>

The laminates of Examples 1 to 24 were continuously produced by 100. As a result, fogging was not observed even in the 100th laminate.

The laminates of Comparative Examples 1 to 3 were continuously produced by 100. As a result, fogging was observed from the 50th laminate.

Here, the fogging refers to a state where the film has a sea-island pattern of several urn to several tens of μm or a phase separation aspect and the film is floating when the laminate is observed from the glass side under an optical microscope and the adhesive surface between the glass and the polyimide film is focused.

As described above, fogging does not occur in the production of polyvalent amine compound layer, but fogging may occur in the production of polyvalent amine compound layer in a case where a silane compound (silane coupling agent) is used. Hence, a laminate having a polyvalent amine compound layer is superior to a laminate having a silane compound layer (silane coupling agent layer) from the viewpoint of not causing fogging in the production thereof. It is presumed that the reason why fogging is observed in Comparative Examples 1-3 is that the silane coupling agent aggregates and the like to form particles during continuous production.

| | Example 1 | Example 2 | Example 3 | Example 4 | Example 5 | Example 6 |
|---|---|---|---|---|---|---|
| Amine compound | TMDA | TMDA | TMDA | HMDA | HMDA | HMDA |
| used | | | | | | |
| Coating method | Spin | Gas phase | Spraying | Spin | Gas phase | Spraying |
| | coating | coating | | coating | coating | |
| Substrate | Glass | Glass | Glass | Glass | Glass | Glass |
| Film | Film 1 | Film 1 | Film 1 | Film 1 | Film 1 | Film 1 |
| Film thickness | 4 | 4 | 5 | 4 | 3 | 5 |
| (nm) | | | | | | |
| Initial peel | 0.13 | 0.14 | 0.14 | 0.12 | 0.13 | 0.12 |
| strength | | | | | | |
| (N/cm) | | | | | | |
| Peel strength | 0.19 | 0.14 | 0.21 | 0.23 | 0.16 | 0.21 |
| after heating | | | | | | |
| at 500° C. | | | | | | |
| (N/cm) | | | | | | |

TABLE 3

| | | | | Example | Example | Example |
|---|---|---|---|---|---|---|
| | Example 7 | Example 8 | Example 9 | 10 | 11 | 12 |
| Amine compound | EDA | DETA | TETA | TMDA | TMDA | TMDA |
| used | | | | | | |
| Coating method | Spin | Gas phase | Spraying | Spin | Gas phase | Spraying |
| | coating | coating | | coating | coating | |
| Substrate | Glass | Glass | Glass | Si wafer | Si wafer | Si wafer |
| Film | Film 1 | Film 1 | Film 1 | Film 1 | Film 1 | Film 1 |
| Film thickness | 4 | 3 | 5 | 4 | 5 | 3 |
| (nm) | | | | | | |
| Initial peel | 0.12 | 0.13 | 0.12 | 0.11 | 0.13 | 0.11 |
| strength | | | | | | |
| (N/cm) | | | | | | |
| Peel strength | 0.23 | 0.20 | 0.16 | 0.17 | 0.21 | 0.22 |
| after heating | | | | | | |
| at 500° C. | | | | | | |
| (N/cm) | | | | | | |

TABLE 4

| | Example 13 | Example 14 | Example 15 | Example 16 | Example 17 | Example 18 |
|---|---|---|---|---|---|---|
| Amine compound | HMDA | HMDA | HMDA | HMDA | TMDA | HMDA |
| used | | | | | | |
| Coating method | Spin | Gas phase | Spraying | Bubbling | Gas phase | Spraying |
| | coating | coating | | | coating | |
| Substrate | Si wafer | Si wafer | Si wafer | Si wafer | Glass | Glass |
| Film | Film 1 | Film 1 | Film 1 | Film 1 | Film 2 | Film 2 |
| Film thickness | 5 | 5 | 5 | 5 | 5 | 5 |
| (nm) | | | | | | |
| Initial peel | 0.11 | 0.12 | 0.13 | 0.13 | 0.11 | 0.14 |
| strength | | | | | | |
| (N/cm) | | | | | | |
| Peel strength | 0.15 | 0.16 | 0.21 | 0.22 | 0.16 | 0.15 |
| after heating | | | | | | |
| at 500° C. | | | | | | |
| (N/cm) | | | | | | |

TABLE 5

| | Example 19 | Example 20 | Example 21 | Example 22 | Example 23 | Example 24 |
|---|---|---|---|---|---|---|
| Amine compound | HMDA | HMDA | TMDA | TMDA | HMDA | HMDA |
| used | | | | | | |
| Coating method | Gas phase | Spraying | Gas phase | Spraying | Gas phase | Spraying |
| | coating | | coating | | coating | |
| Substrate | Si wafer | Si wafer | Glass | Glass | Si wafer | Si wafer |
| Film | Film 2 | Film 2 | Film 3 | Film 3 | Film 3 | Film 3 |
| Film thickness | 5 | 5 | 5 | 5 | 5 | 5 |
| (nm) | | | | | | |
| Initial peel | 0.1 | 0.1 | 0.13 | 0.18 | 0.15 | 0.14 |
| strength | | | | | | |
| (N/cm) | | | | | | |
| Peel strength | 0.13 | 0.15 | 0.15 | 0.19 | 0.16 | 0.13 |
| after heating | | | | | | |
| at 500° C. | | | | | | |
| (N/cm) | | | | | | |

TABLE 6

| | Comparative | Comparative | Comparative | Comparative |
|---|---|---|---|---|
| | Example 1 | Example 2 | Example 3 | Example 4 |
| Amine | APS | APS | AEAPS | Nil |
| compound | | | | |
| used | | | | |
| Coating | Gas | Spraying | Gas | Nil |
| method | phase | | phase | |
| | treatment | | treatment | |
| Substrate | Glass | Glass | Si wafer | Glass |
| Film | Film 1 | Film 3 | Film 1 | Film 1 |
| Film | 13 | 41 | 17 | — |
| thickness | | | | |
| (nm) | | | | |
| Initial | 0.17 | 0.02 | 0.14 | 0.02 |
| peel | | | | |
| strength | | | | |
| (N/cm) | | | | |
| Peel | 0.54 | 0.042 | 0.35 | 0.17 |
| strength | | | | |
| after | | | | |
| heating | | | | |
| at 500° C. | | | | |
| (N/cm) | | | | |

1. A laminate comprising:
a heat-resistant polymer film;
an inorganic substrate; and
a polyvalent amine compound layer formed using a polyvalent amine compound, wherein
the polyvalent amine compound layer is formed between the heat-resistant polymer film and the inorganic substrate.

2. The laminate according to claim 1, wherein a 90° initial peel strength between the heat-resistant polymer film and the inorganic substrate is 0.05 N/cm or more.

3. The laminate according to claim 1, wherein a 90° peel strength between the heat-resistant polymer film and the inorganic substrate is 0.5 N/cm or less after the laminate is heated at 500° C. for 1 hour.

4. A method for producing a laminate, the method comprising:
a step A of forming a polyvalent amine compound layer on an inorganic substrate; and
a step B of bonding a heat-resistant polymer film to the polyvalent amine compound layer.

5. The method for producing a laminate according to claim 4, wherein a 90° initial peel strength between the heat-resistant polymer film and the inorganic substrate after the step B is 0.05 N/cm or more.

6. The method for producing a laminate according to claim 4, wherein a 90° peel strength between the heat-resistant polymer film and the inorganic substrate is 0.5 N/cm or less after the step B and the laminate is further heated at 500° C. for 1 hour.

7. The method for producing a laminate according to claim 5, wherein a 90° peel strength between the heat-resistant polymer film and the inorganic substrate is 0.5 N/cm or less after the step B and the laminate is further heated at 500° C. for 1 hour.

8. The laminate according to claim 2, wherein a 90° peel strength between the heat-resistant polymer film and the inorganic substrate is 0.5 N/cm or less after the laminate is heated at 500° C. for 1 hour.
